(19) United States
(12) Patent Application Publication
(10) Pub. No.: US 2009/0183002 A1
(43) Pub. Date: Jul. 16, 2009

(54) Method and device for automatically creating backup copies

(75) Inventors: Robert Rohrer, Vienna (AT); Peter Stelzer, Gratkorn (AT)

Correspondence Address: CHAPMAN AND CUTLER, 111 WEST MONROE STREET, CHICAGO, IL, 60603, US

(73) Assignee: Data Noah GmbH, Graz (AT)

(21) Appl. No.: 12/288,651

(22) Filed: Oct. 22, 2008

(30) Foreign Application Priority Data
Oct. 24, 2007 (AT) A 1729/2007

(51) Int. Cl. G06F 17/30; H04L 9/32

(52) U.S. Cl. 713/168; 707/204; 707/E17.005; 707/E17.01

(57) ABSTRACT

In a method for automatically creating backup copies and for remote archiving of files from at least one electronic data processing equipment, files are compressed in a device separated from the data processing equipment, in particular in a supplementary data processing device, their contents and, where appropriate, their names are encrypted, and then are transferred via a network to a remote archive in a controlled fashion. The supplementary data processing device includes a file repository (10), an interface for a data connection between the data processing equipment (6) and the supplementary data processing device (1), a means for providing server services in order to allow the data processing equipment (6) a write/read access to the file repository (10), a data compression means (12), a data encryption means (13) and a data transmission means (14), wherein the device (1) is mounted in a closable case separate from the data processing equipment (6).

Applicant claims priority to and incorporates by reference Austria App. Ser. No. A 1729/2007, filed Oct. 24, 2007.

The present invention relates to a method for automatically creating backup copies and for remote archiving of files from at least one electronic data processing equipment as well as a supplementalary data processing device for performing this method.

Since the beginning of electronic data processing, various means and methods have been created to avoid data loss due to human or technical failure. The kinds of data storages have developed rapidly. The data media range from mechanical data carriers (punched tapes) and microfilms, through magnetic storages such as magnetic tapes, magneto-optical storages (magneto-optical discs, hard disks) and optical storages such as recordable CDs and recordable DVDS (Digital Versatile Disks) to electrically programmable semiconductor storages (e.g. silicon storage chips), for example in pen drives or memory cards.

Meanwhile, the data amount and density have grown manifold over the years. If a storage medium is damaged or data is deleted by mistake, the recovery of data can incur high costs or high efforts. The transfer from one storage medium (possibly an obsolete one) to another or a new one can also be very costly.

Thus, it proved to be advantageous to perform an archive copy of important data to newer storage media at regular or irregular intervals in an automated or manual way. This allows to undo an inadvertent deletion or overwriting or, if a storage medium fails, to transfer backed up data to a replaced new storage medium. By properly selecting the backup time points, the backup frequency and the kind of information, the possible data loss can be restricted to a minimum.

Certain programs (e.g. graphics programs) allow to undo a certain number of editing steps and then to redo them again. The last action step applied to files, if intentional or not, can be undone in most operating systems. With so-called recycle bin functions, whereby the final intentional deletion happens only later, a “last repository” was created. Thereby the risk of deletion by mistake was somewhat reduced.

Data backup programs allow the backup of entire file directories or hard disk partitions to other storage places (e.g. other directories or other hard disks or other hard disk partitions). These programs can compress data before backup and also save or encrypt them with passwords. For compression, redundancy reducing methods are applied (Winzip, Huffmann, LZW, ART, PPM (Prediction by Partial Matching)). This increases the information density by storing frequent (redundant) character sequences with few characters by means of referencing.

Passwords restrict the file reading authorisation. This allows a certain security against unauthorized access. All possible character combinations can however be determined by rapid computing programs in a time depending on the password length.

Encryption algorithms, such as PGP (Pretty Good Privacy) or Blowfish 448, Triple-Fish or the like, encode files by cyclic linking with itself with the help of encoding keys. Data can be decrypted only with the appropriate decoding key. The computing time required for a possible decryption with the help of the fastest computers is determined by the key size (number of encryption bits) and can be as long as decades. Such encryptions are considered as almost impossible to decrypt.

Alternative storages for data backup also offer protection in case of technical failure of a storage medium. Should a hard disk become corrupted, for example, the data thereon may become unreadable. A backup copy on a second hard disk, a CD or a DVD allows a recovery to a new, recovered or mistakenly or intentionally erased or formatted hard disk.

In case of disaster such as fire, earthquake or vandalism, data or storage media on site may be destroyed or lost. For this purpose, sensible data (belonging to banks, insurance companies and government authorities) are transferred to especially secure places external to the companies, often to computing centers. For this purpose, a dedicated line or a secured connection over the worldwide data network Internet is used. In case of power outages, buffer batteries or electrical accumulators provide support as additional power providers. Portable computers such as notebooks offer monitoring functions which perform data backups before the complete supply outage.

The use of the Internet connection represents a special challenge to the data security with respect to third party access.

The outsourcing of data maintenance to computing centers can obviate the requirement for constantly transferring older data to new storage mediums, which is particularly advantageous when reading devices for old storage media are not longer available. Likewise, neither tapes, DVDs nor CDs have to be logistically maintained and managed internally or externally, such as storing them in armoured closets, safes or the like.

What is essential for most known means and methods of data backup is the adoption of network computers (servers) for managing and storing or backing-up of data (preferably by magnetical recording to tape). This includes transferring data between connected computers (Intranet) or to printing devices. Transferring data from and to the worldwide data network (Internet) by means of electronic message programs (E-mail) is also possible. In addition, the retrieval of websites of other worldwide server devices or the provision of own websites for other data network participants (restricted or not) can be carried out.

EP 0 732 661 B1 describes a method and a system by which information can be archived through a communication network.

A drawback of this and other known methods is the use of open standards for the data transfer or the cumbersome installation and usage of different and possibly unstable software products directly on the server computers or standalone computers (for transferring, compressing and encrypting) of different more or less reputable manufacturers, which eventually makes the security with respect to third party access to data during transfer not ideal. Complex login and storage routines complicate the access for consumers.

An object of the present invention is to provide a preferably hardware supported plug and play solution by which a secure data archiving with a minimum of user intervention is possible. In particular, an object of the invention is to provide a device and a method for creating backup copies and remotely archiving files from electronic data processing equipment, wherein the data backup is carried out in a fully automated manner, so that the user is freed from any responsibility for the backup process. The contents of the backed up data should be reliably protected from third party access. The realization of the method or the device should be substantially possible without complex installation steps, so that the number of sources of error can be minimized.

To solve this object, the method of the invention is characterized in that files are compressed in a device separated from the data processing equipment, in particular in a supplementary data processing device, their contents and, where appropriate, their names are encrypted, and are then transferred via a network to a remote archive in a controlled fashion. In that the data backup operation is performed in a device separate from the data processing equipment, in particular in a supplementary data processing device, and controlled by this device, respectively, no access into the actual data processing equipment takes place, so that the requirement of complex installation steps for this device is eliminated. Such a device separated from the data processing equipment can be provided to the user as a simple hardware box connectable to existing data processing equipments such as computers or network servers. Here, the connection is preferably performed using standard interfaces such as LAN, WLAN, Bluetooth, USB or FireWire.

In that the data is compressed and according to the invention their content and, where appropriate, their filenames are encrypted the storage place required for the data backup is reduced, wherein the encryption allows to protect the files content confidentiality. As not only the contents of a file but also the filename itself may contain confidential data, the filename is preferably also encrypted. The necessity of encryption also arises in particular from the circumstance that the files are transferred to a remote archive via a network. Hereby, the remote archive can be accommodated in premises which are subject to special security measures and are in particular protected against external access, harmful environmental influences or natural disasters and fire and the like. The remote archive such as a central backup server should preferably not be located in the vicinity of the computers to be backed up, and it should be ideally located in a computing center optimally equipped and monitored for this purpose.

In that the data backup is performed in a separate, external hardware box such a hardware box can be provided fully pre-installed so that it is not necessary that the user performs further installation steps, except connection to the network (Internet). On that occasion, the hardware box preferably should be able to take over server functions such as the central file or program management for local networks or the connection of network printers. Preferably, services of data conversion (format A to format B, e.g. all printable files to the Portable Document File (PDF) format) should also be implementable. Preferably, the removal or opening of the hardware box by non-authorized persons should be detected for security reasons, and access to the remotely archived, encrypted and compressed files should be prohibited.

According to a preferred approach, the highest level of security should be guaranteed by encrypting the data using a key inaccessible for the electronic data processing equipment. A further improvement in security is preferably achieved by encrypting the data using a key derived from systemwide-constant but specific component information such as processor serial numbers or the like. By using at least one special integrated key for encrypting and decrypting the data filed for archiving, access for non-authorized people can be effectively prohibited.

The parameters and options of the data transfer between the supplementary data processing device and the remote archive, such as transfer frequency (intervals), transfer times, depth of modification tracking, data amount, transfer speed and method of logging, should be allowed by secure website accesses or by administrator access via the data line to the hardware box.

A particular challenge is to not only save the individual files in their final version but also to detect every modification of the files, i.e. a modification of their contents, and to save the modification. By means of such a differential backup it is possible to recover a certain modification stage of a file, if desired. For this purpose, the preferred approach within the scope of the inventive method is that a difference data calculation is effected for modified files to create a difference file and to link the modifications to the original file and transfer them in the encrypted state to the remote archive.

To reduce the data amount, it is hereby preferably proceeded that the data of the difference file is compressed before encryption.

In this context, an optimization can preferably be achieved in that the file sizes of the difference file, the compressed difference file and the compressed modified file are compared and the smallest of these files is selected for encryption and transfer to the remote archive, so that in effect the smallest possible amount of data will be transferred.

To associate the individual files at the place of origin with the corresponding files in the remote archive, it is preferably envisaged that files that have already been transferred are marked and connected by hard links and that the presence of a hard link prevents a repeated transmission.

The supplementary data processing device which is preferably adopted within the scope of the inventive method is substantially characterized in that it includes
a file repository,
an interface for a data connection between the data processing equipment and the supplementary data processing device,
server services for allowing the data processing equipment a write/read access to the file repository,
a data compression means for compressing the data stored in the file repository,
a data encryption means for encrypting the data which is stored in the file repository and is potentially compressed, and
a data transmission means for transmitting the encrypted and potentially compressed data to the remote archive,
   wherein the device is mounted in a closable case separate from the data processing equipment.

Thus, the inventive supplementary data processing device includes, with the exception of the remote archive, all the components required for the backup.

Preferred embodiments of the supplementary data processing device will be understood from the above description of the inventive method and will thus only be summarized shortly in the following.

Preferably, the data encryption means provided in the supplementary data processing device includes an encoding key consisting of systemwide-constant but specific component information such as processor serial numbers or the like.

To ensure an autonomous operation of the supplementary data processing device, it preferably includes an autonomous operating system which is preferably stored on a fixedly-programmed medium, in particular on a memory card (flash card).

Furthermore, a stable microprocessor unit is preferably provided which is most preferably fanless.

To facilitate the recovery of the backed up data, a means for data recovery with decryption and recovery of the original data is preferably provided.

To allow a differential backup, the supplementary data processing device preferably includes a difference data computation means.

In order to further improve the uniformity and standardization of the files to be stored, the supplementary data processing device preferably includes a data conversion means, in particular a file format conversion means.

In a simple manner, the file repository is built as a hard disk storage, wherein the use of solid-state storages without moving parts such as flash memories increases the service life and the reliability.

A structure which is particularly failure-proof and protected against user interventions is preferably achieved when the data compression means, the data encryption means and, where appropriate, the filename encryption means and the difference data computation means are constructed of hard-wired components (hardware).

The data transmission from the supplementary data processing device to the remote archive can be performed using standard protocols, so that the data transmission means can consist of an Ethernet, USB and/or FireWire (IEEE 1394) interface.

To ensure a regular data backup, a controller is advantageously provided for initiating the transmission of backup copies to the remote archive at pre-defined times.

Hereinafter, the invention will be explained in detail by illustrative embodiments shown in the drawings. In which,

FIG. 1 shows a typical configuration of a supplementary data processing device,

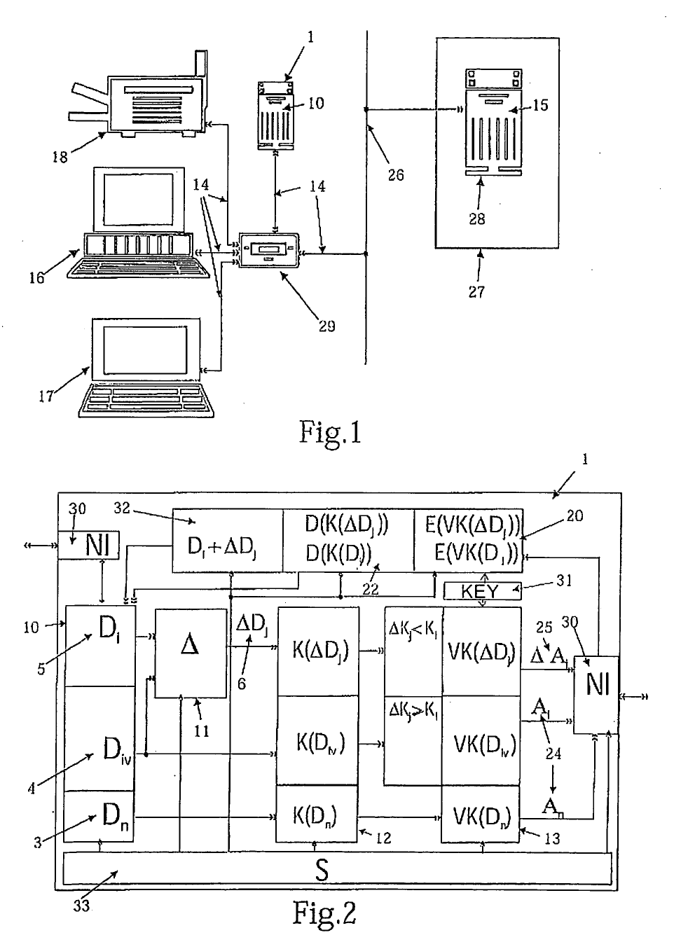

FIG. 2 shows the basic functional blocks of the device according to FIG. 1, and

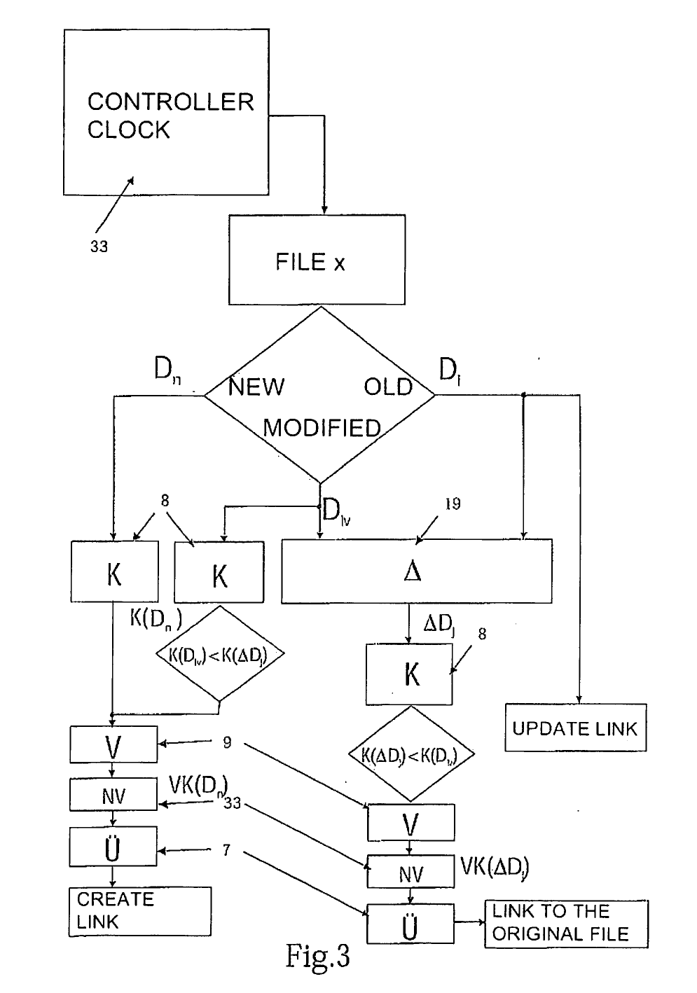

FIG. 3 shows a flow chart according to an embodiment of the inventive method.

In FIG. 1, two computers 16, 17 are connected to the supplementary data processing device 1 which is a hardware box. Preferably, a local network connection (LAN, Local Area Network) or a FireWire IEEE 1394 or USB (Universal Serial Bus) connection can be used to connect to the box. Thereby, the access to the local storage medium 10 (preferably, a hard disk drive) in the device 1 is achieved in an automated manner. This appears in the operating systems of connected computers and can be fully used as a medium for storing working data. All files 3, 4 stored in this storage 10 of the device 1 arrive compressed and encrypted at the remote archive 15 of a secured computing equipment 28 in a secured storage place 27 (e.g., in a computing center) after the automated, time-controlled processing by the device. From there, they can at any time be decrypted and decompressed by the device 1 and made available again in the storage 10.

FIG. 2 outlines the internal structure of the device 1. The storage 10 (e.g. a hard disk) is usable for a connected computer via the connection means (network interface NI) 30 of a local network (e.g., Ethernet 100 Mbit).

All files Dn 3 that have been newly stored in the local storage 10 of the supplementary data processing device 1 are transferred via the network interface to the remote archive 15 at pre-defined or definable times through the flow control 33 with the help of the data compression means 12 and the data encryption means 13. If the transfer was carried out error-free, a hard linking to the original files is performed.

By this measure these files are detected as sent and marked. A repeated transmission is avoided. Here, the files which have already been sent are indexed with an i (Di). At the time of the next transfer only a new hard linking to the backed up file is made.

Erasing a file causes deletion of the link in the remote archive 15, but not of the previously saved file.

If the file which has already been transferred is further processed (modified), a difference file 6 is determined from the original file 5 and the modified file 4 by the difference data computation means 11. As a result, a compressed file is formed from both the modified file 4 and the difference file 6 by the data compression means 12, and they are compared with respect to their size. Depending on which file is smaller, either the compressed difference file or the compressed modified file is encoded by the data encryption means 13 and transferred through the network interface 30.

The data encryption means 13 also encrypts the name of the file. A hard link remains on the encrypted compressed difference file, whereby it is always ensured that the modified file can be restored from the original file and the associated difference file. When stored files are lost or are mistakenly erased, these files can be loaded back from the files in the remote archive 15 again, provided that a data transmission was performed. For this purpose, a decryption means 20 with the same key 31 as was applied for the encryption and which is only available to the device 1 is used. A detection or read-out of the key is impossible or virtually impossible. The use of component identification codes such as microprocessor identification—and serial numbers or the like for key generation is one of the possibilities for mapping a key that is not known to anyone but is uniquely assignable. After decryption the original files or the difference files are created by the decompression means 22. Through the means 32 the recovery of the modified file 4 from the file before the modifications 5 and from the difference file 6 is performed.

The concrete method 2 for data backup is clarified in FIG. 3. By means of a data compression method 8, an arbitrary file Dn can be modified to a file of higher data density, i.e. fewer information units, with the help of software and/or hardware.

In a further step this compressed file is modified by the data encryption 9, wherein the data is scrambled through an encoding algorithm (symmetrically or asymmetrically) and thus is neither decompressable nor decryptable, unless the proper decryption key is available. The filename is also subjected to encryption in a further step. Then the transfer 7 is performed. The recovery of the data is carried out in reverse order from the encrypted compressed archive data. If these are retrieved via the network possibly using the user name and password, the recovery of the archive file is performed with the help of the key 31 and the decryption 21 and the subsequent decompression 23. The name is also decrypted again.

With the help of a data encryption means each compressed file is encrypted to a new unreadable format, wherein the encryption function is performed through a known (e.g., Blowfish 448, Triple-Fish) or unknown algorithm with the help of an encoding key which is hidden in the device, difficult to read out and worldwide unique. Apart from the contents of the files, their name can also be encrypted to achieve the highest confidentiality.

The encrypted compressed files are transferred at definable times to the backup server (preferably located in the computing center) with the help of a remote transfer means for data (e.g., Ethernet interface 100 Mbit). There, the logistic storage of the file is performed, specifying the date, the time and the source allocation.

Ideally, the maximum amount of data that can be stored, the version depth of a file, the backup frequency and other parameters are adjustable. This can be performed by a storage space provider in a computing center or by the user according to his/her authorization level. The access to these management functions is also ideally performed via the network (e.g., the Internet). Modifications of the basic settings require access rights (via user names and passwords). Each new setting can, for example, trigger an electronic message with the contents of the new management setting. In order to prevent damaging actions of hackers (file burglars) to the highest possible degree, the variation possibilities for the backup are preferably very low, and a fixed setting is also possible. For the public network the encrypted and compressed data is accessible only with the user name and password. The transfer is likewise performed in a secure encrypted channel transfer protocol such as SSH tunnel.

To prevent repeated transfers of files which have already been backed up, hard links are used. These are pointers which point to a backed up file in the backup server (e.g., in the computing center) and represent a link to the original file. If a file that is linked in such a way is modified or erased in the interim repository according to the invention (intentionally or unintentionally), the system detects these modifications before or after a backup operation. On that occasion, the modified file and the modifications of the original file are compressed (difference data compression). Depending on which option requires less storage space, either the modified compressed file or the compressed modification file (difference file) is stored and transferred in the encrypted state at an allocated time. In the second case a hard link of the original file to the difference file is created, and in the first case a new hard link to the new backed up file is created during backup. If no modification is made, only the hard link with the backup time information is transferred. Thus, in case of a possible data recovery, the linked file is accessed. If a file is erased after a backup operation, no new hard link information is transmitted anymore at the time of a new backup operation. However, the backed up file of the previous backup is maintained.

### LIST OF REFERENCE NUMBERS

1 Supplementary data processing device
2 Method of data backup
3 New file (not archived), Dn
4 Modified file with respect to an archived file
5 Archived file Di
6 Difference file (ΔD)
7 Data transfer
8 Data compression
9 Data encryption
10 Local repository in the device 1
11 Difference data computation means
12 Data compression means
13 Data encryption means
14 Data transmission means
15 Remote archive (storage)
16 Computing equipment (stationary), for example PC, workstation
17 Computing equipment (portable), for example notebook
18 Printer
19 Difference data computation
20 Decryption means
21 Decryption
22 Decompression means
23 Decompression
24 Encrypted compressed archive file (Ai, An)
25 Encrypted compressed archive difference file (ΔAj)
26 Network
27 Secured location (e.g., computing center)
28 Secured computing equipment
29 Network server (network node with XDSL, ADSL, ISDN or analog modem connection)
30 Network interface (LAN, USB, FireWire IEEE 1394)
31 Hidden key (for encoding and decoding means)
32 Means for creating the original file from the basic file and its variation(s)
33 Flow control
34 Filename encryption

1-20. (canceled)

21. Method for automatically creating backup copies of electronic files and for remote archiving of electronic files from at least one electronic data processing equipment, comprising the steps of:
compressing the files in a device separate from the data processing equipment, wherein the separate device is a supplementary data processing device;
encrypting contents of the files and encrypting names of the files; and
transferring the encrypted files and names via a network to a remote archive in a controlled fashion.

22. Method according to claim 21, wherein the encryption is conducted using a key inaccessible to the electronic data processing equipment.

23. Method according to claim 21, wherein the encryption is conducted using a key derived from systemwide-constant but specific component information.

24. Method according to claim 21, wherein difference data is calculated for a modified file modified from an original file, to yield a difference file, and modifications are linked to the original file and transferred in an encrypted state to the remote archive.

25. Method according to claim 24, wherein data compression of the difference file is performed before the encryption, to yield a compressed difference file.

26. Method according to claim 25, wherein
the modified file is compressed, to yield a compressed modified file;
file sizes of the difference file, the compressed difference file, and the compressed modified file are compared;
and one of said compared files having a smallest file size is selected for encryption and transfer to the remote archive.

27. Method according to claim 21, wherein files that have been transferred are marked and connected by hard links, and a presence of a hard link prevents a repeated transmission.

28. Method according to claim 23, wherein the systemwide-constant but specific component information comprises processor serial numbers.

29. Method for automatically creating backup copies of electronic files and for remote archiving of electronic files from at least one electronic data processing equipment, comprising the steps of:
compressing the files in a device separated from the data processing equipment, wherein the device is a supplementary data processing device;
encrypting contents of the files; and
transferring the encrypted files via a network to a remote archive in a controlled fashion.

30. Supplementary data processing device for creating backup copies of electronic files from at least one electronic data processing equipment and for transmitting the backup copies to at least one remote archive, for carrying out the method according to claim 19, wherein the device comprises:
a file repository (10),
an interface for a data connection between the data processing equipment (6) and the supplementary data processing device (1),
server services for allowing the data processing equipment (6) a write/read access to the file repository (10),
a data compression means (12) for compressing the data stored in the file repository (10),
a data encryption means (13) for encrypting the data stored in the file repository, and
a data transmission means (14) for transmitting the encrypted data to the remote archive,
wherein the device (1) is mounted in a closable case separate from the data processing equipment (6).

31. Supplementary data processing device according to claim 30, wherein the data encryption means (13) comprises an encoding key of systemwide-constant but specific component information.

32. Supplementary data processing device according to claim 30, wherein the device comprises an autonomous operating system which is stored on a fixedly-programmed medium, and wherein the medium is a memory card.

33. Supplementary data processing device according to claim 30, wherein the device comprises a means for data recovery providing decryption and restoration of original data.

34. Supplementary data processing device according to claim 30, wherein the device comprises a filename encryption means (34).

35. Supplementary data processing device according to claim 30, wherein the device comprises a difference data computation means (11).

36. Supplementary data processing device according to claim 30, wherein the device comprises a data conversion means, and wherein the data conversion means is a file format conversion means.

37. Supplementary data processing device according to claim 30, wherein the file repository (10) is a hard disk storage.

38. Supplementary data processing device according to claim 30, wherein the data compression means (12) and the data encryption means (13) are constructed of hard-wired components.

39. Supplementary data processing device according to claim 30, wherein the data transmission means (14) comprises at least one selected from the group consisting of an Ethernet interface, a USB interface, and a FireWire (IEEE 1394) interface.

40. Supplementary data processing device according to claim 30, wherein the device comprises a controller for initiating transmission of backup copies to the remote archive at predefined times.

41. Supplementary data processing device according to claim 31, wherein the systemwide-constant but specific component information comprises processor serial numbers.
